(19) United States
(12) Patent Application Publication
(10) Pub. No.: US 2010/0006549 A1
(43) Pub. Date: Jan. 14, 2010

(54) DEVICE FOR PROCESSING MATERIALS BY LASER BEAM

(75) Inventors: Heui Jae Pahk, Seoul (KR); Tai Wook Kim, Seoul (KR); Heung Hyun Shin, Seoul (KR)

Correspondence Address: CLARK & BRODY, 1090 VERMONT AVENUE, NW, SUITE 250, WASHINGTON, DC, 20005, US

(73) Assignee: SNU PRECISION CO., LTD., Seoul (KR)

(21) Appl. No.: 12/448,642

(22) PCT Filed: Jun. 15, 2007
(86) PCT No.: PCT/KR2007/002925

§ 371 Date: Jun. 29, 2009

(30) Foreign Application Priority Data
Mar. 13, 2007 (KR) 10-2007-0024482

(51) Int. Cl. B23K 26/00

(52) U.S. Cl. 219/121.76

(57) ABSTRACT

Disclosed is a laser processing device for processing a surface of an object with laser beams. The laser processing device includes: a laser beam generating unit for projecting laser beams; and a micromirror device having a plurality of micromirrors, the micromirrors being configured to reflect and transfer at least a part of laser beams projected from the laser beam generating unit to the surface of the object in a pattern for processing the surface of the object in a desired shape. The micromirrors of the micromirror device are capable of selectively switching the light path of the laser beams projected from the laser beam generating unit. According to the present invention, a surface of an object can be either two-dimensionally or three-dimensionally processed in a desired shape with laser beams.

### BACKGROUND OF THE INVENTION

1. Field of the Invention

The present invention relates to a laser processing device for processing a surface of an object with laser beams, and more particularly, to a laser processing device for processing an object to a desired shape by using a micromirror device having a plurality of micromirrors.

2. Description of the Related Art

Generally, lasers are frequently used so as to process foreign materials or a defective area produced on a flat display substrate. In such a case, it is possible to process an area desired to be processed on an object to a desired shape by adjusting the intensity and pattern of laser beams outputted from a laser beam generator.

FIGS. 1 and 2 show methods for processing a surface of an object, such as foreign materials or a defective area. FIG. 1 is a cross-sectional view showing a laser processing device for processing an object with laser beams according to prior art, and FIG. 2 is a cross-sectional view showing an auxiliary beam supply device according to prior art.

As shown in FIG. 1, the conventional laser processing device includes a slit 100 and a beam splitter 200. Laser beams L generated by a laser beam generator passes through the slit 100 via the beam splitter 200. The laser beams L1 pass through the slit 100 and then arrive at an object A. As such, the object A can be processed according to the pattern formed by the laser beams passing through the slit 100. At this time, by using a plurality of such slits 100 or changing the pattern of the slit 100, it is possible to form a desired shape on the surface of the object.

If the shape of the object to be processed is simple, it is possible to arrange a slit 100 with a processing pattern corresponding to the shape in the laser beam path so as to process the object. However, there is a problem in that if the shape of an object to be processed is intricate or curved, it is difficult to arrange a slit 100 with a desired processing pattern corresponding to the shape so as to process the object.

That is, when a curved or intricately shaped object is processed, it is difficult to process the object to a desired shape. Even if the intricate shape is divided into a plurality of small areas so as to divisionally process the shape, the length of time required for processing the object is excessively long, whereby the processing costs will be increased.

In addition, because there is no means for adjusting the intensity of laser beams L used in processing such an object, it is difficult to control a depth to be processed on the object.

Meanwhile, as shown in FIG. 2, it is possible to observe a shape to be processed on the object A in advance prior to processing the object by causing auxiliary beams M to be incident into a slit 100 through a beam splitter 200 and then observing auxiliary beams M1 arriving at the object. Even in such a case, there is also a problem in that it is difficult to precisely observe the shape to be processed on the object if the object has an intricate or curved shape.

### SUMMARY OF THE INVENTION

Accordingly, the present invention has been made in view of the above-mentioned problems occurring in the prior art, and it is an object of the present invention to provide a laser processing device capable of precisely processing a intricately shaped or curved surface of an object within a short time.

It is another object of the present invention to provide a laser processing device capable of controlling a depth processed on an object by controlling the power of laser beams.

It is yet another object of the present invention to provide a laser processing device which allows a shape formed on an object to be observed by using auxiliary beams when the object is processed by laser beams.

In order to achieve the above-mentioned objects, there is provided a laser processing device for processing a surface of an object with laser beams including: a laser beam generating unit for projecting laser beams; and a micromirror device having a plurality of micromirrors, the micromirrors being configured to reflect and transfer at least some of the laser beams projected from the laser beam generating unit to the surface of the object in a pattern for processing the surface of the object to a desired shape, wherein each micromirror in the micromirror device is capable of selectively switching the light path among two light paths as desired.

Preferably, each micromirror is adapted to select one of two positions by applying electric voltage to one of the opposite ends thereof, so that the micromirror can selectively switch the light path thereof among two light paths.

The micromirror device may be a digital micromirror device, which executes the selection of the desired light path among the two light paths through a semiconductor switching circuit control circuit.

In addition, the micromirror device may control the power of laser beams irradiated to an area of the surface of the object desired to be processed by switching the light paths of some micromirrors among the micromirrors corresponding to the area of the surface of the object to be processed.

Meanwhile, the micromirror device may control the power of laser beams irradiated from a micromirror by controlling the length of time for switching the light path of the micromirror.

Alternatively, the micromirror device controls a depth processed on the surface of the object by controlling the times of switching the light path of the micromirror per unit time.

The inventive laser processing device may further comprise an auxiliary beam generating unit separately arranged from the light path of the laser beam generating unit so as to generate auxiliary beams, so that the surface of the object desired to be processed can be observed.

Preferably, the inventive laser processing device may further comprise a dichroic mirror for rendering the light paths of the auxiliary beams projected from the auxiliary beam generator to be equal to the light paths of the laser beams projected from the laser beam generating unit.

According to the inventive laser processing device configured as described above, it is possible to precisely process a intricately shaped or curved object within a short length of time unlike the prior art.

By controlling the power of laser beams, it is possible to control the depth of an area processed on an object as well as to process the area in a three-dimensional shape.

In addition, by controlling the power of laser beams, it is possible to control a processing depth on an object.

Furthermore, by employing auxiliary beams at the time of processing an object with laser beams, it is possible to process the object while observing a processing shape.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a cross-sectional view illustrating a conventional laser processing device according to the prior art;

FIG. 2 is a cross-sectional view illustrating a conventional auxiliary beam supply device according to the prior art;

FIG. 3 is a cross-sectional view illustrating the inventive laser processing device;

FIG. 4 is a cross-sectional view illustrating an embodiment in which a micromirror has changed its position in the inventive laser processing device;

FIG. 5 is a conceptual view illustrating how to process an object with the inventive laser processing device;

FIGS. 6 to 10 are conceptual views illustrating how to change the power of laser beams by moving micromirrors in the inventive laser processing device;

FIG. 11 is a cross-sectional view illustrating an embodiment of an auxiliary beam generating unit in the inventive laser processing device; and

FIG. 12 is a cross-sectional view illustrating another embodiment of the auxiliary beam generating unit in the inventive laser processing device.

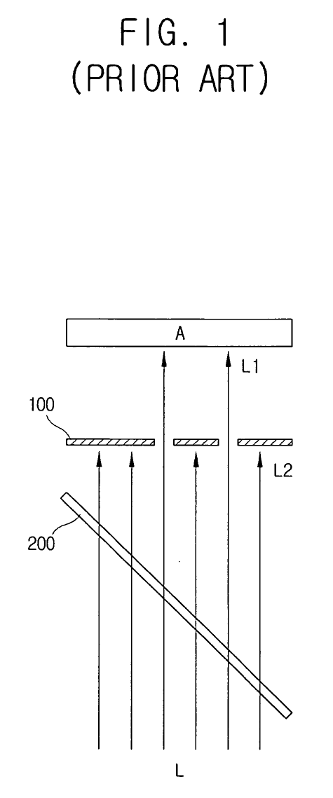

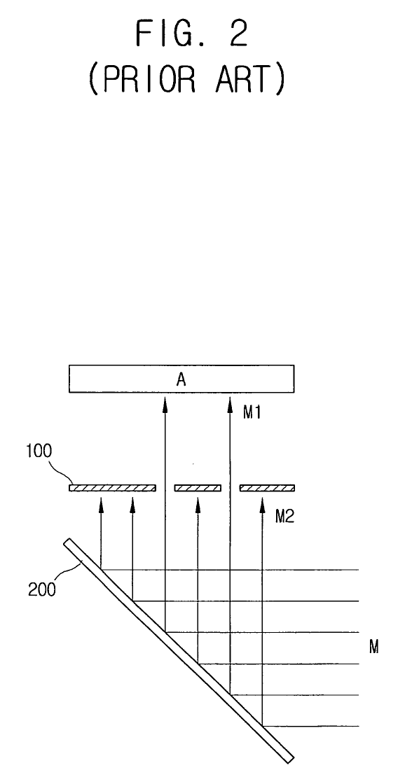

### DETAILED DESCRIPTION OF THE INVENTION

Reference will now be made in detail to the preferred embodiments of the present invention, examples of which are illustrated in the accompanying drawings.

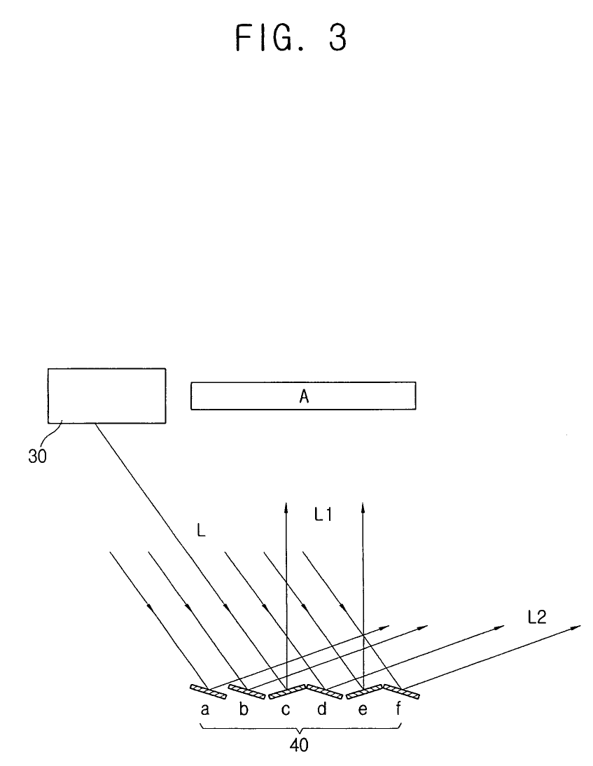

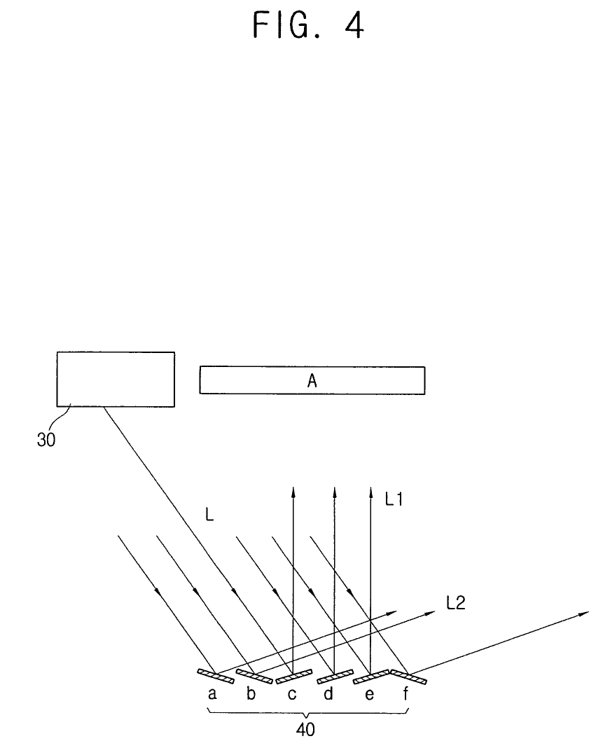

FIG. 3 is a cross-sectional view illustrating the inventive laser processing device, and FIG. 4 is a cross-sectional view illustrating an embodiment in which a micromirror has changed its position in the inventive laser processing device. As shown in the drawings, the inventive laser processing device includes a laser beam generating unit 30 and a micromirror device 40.

The laser beam generating unit 30 is a device for projecting laser beams to the micromirror device 40, and is located at a distance from the micromirror device 40.

The micromirror device 40 is constructed to selectively transmit some of the laser beams projected from the laser beam generating unit 30 to the surface of an object A. That is, some of the laser beams L incident into the micromirror device 40 from the laser beam generating unit 30 will be incident into the object A. For this purpose, a plurality of micromirrors 41 are provided in the micromirror device 40.

A micromirror means a fine mirror, and a plurality of such micromirrors 41 are arranged in the micromirror device 40, wherein the arranged micromirrors 41 can be individually driven by a predetermined method. Methods for individually driving the micromirrors include a method of moving a micromirror left or right by applying electric voltage to one of the opposite sides thereof, and a method of deforming the shape of a micromirror by applying electric voltage to the central part thereof, thereby switching the light paths of the micromirror.

For example, it is assumed that the method of moving a micromirror 41 left or right by applying electric voltage to the left end or right end thereof is employed. In such a case, it is possible to make the micromirror 41 take one of two positions by applying the electric voltage to one of the opposite ends of the micromirror 41.

For example, a digital micromirror device developed by Texas Instruments (TI) of U.S.A. may be employed as the micromirror device. The digital micromirror device includes a semiconductor chip, in which several to hundreds of thousands of driving micromirrors (cells) integrated in a flat plate form. That is, the size of one cell is very small, which is determined by a micro unit. Typically, the digital micromirror device 40 is operated in such a manner that it enlarges and projects an image signal inputted from a computer or an AV appliance, such as a VCR. In addition, because such a micromirror device includes hundreds of thousands of micromirrors for switching the paths of reflected beams no more than several times per sec to hundreds of thousands of times per sec, each of the micromirrors can control collected beams in a digital method. Typically, each of the micromirrors in the digital micromirror device is turned leftward or rightward by electric voltage, thereby being positioned in a desired orientation.

Next, the construction for selecting laser beams reflected from the micromirror device will be described. Each of the micromirrors 41 arranged in the micromirror device 40 can selectively take any of two positions. For example, each micromirror 41 is controlled so that it can selectively take one of two light path positions, which are formed by a laser beam L1 arriving at the object, and a laser beam L2 not arriving at the object, among the laser beams L incident into the micromirrors 41. As each of the micromirrors 41 arranged in the micromirror device 40 switches the light path as mentioned above and laser beams L1 reflected from selected micromirrors 41 arrives at an area to be processed, the surface of the object can be processed.

By operating in this manner, each of the micromirrors 41 arranged in the micromirror device 40 is positioned in a desired orientation so that a desired light path can be selected among the two light paths, and the pattern of laser beams L1 irradiated to the object can be determined by the micromirrors 41 positioned in the light path incident into the object A (the micromirrors denoted by c and e in FIG. 3). As a result, the shape to be processed on the object can be determined. That is, because the micromirrors 41 are fine driving mirrors 41, the micromirrors 41 positioned in an area corresponding to the shape to be processed reflect the laser beams L1 in a pattern corresponding to the shape to be processed, and each of the micromirrors 41 positioned in the remaining area (the micromirrors denoted by a, b, d and f) reflects laser beams L2 to be directed to the other light path not incident into the object, whereby the corresponding shape can be processed on the object.

Meanwhile, as can be seen from FIG. 4, if it is desired to turn a laser beam L2, which is reflected not to be incident into the object, to be directed to the object, it is possible to change the direction of the micromirror 41 corresponding to the laser beam L2 (the micromirror denoted by d in FIGS. 3 and 4), so that the path of the laser beam is changed to be directed to the object.

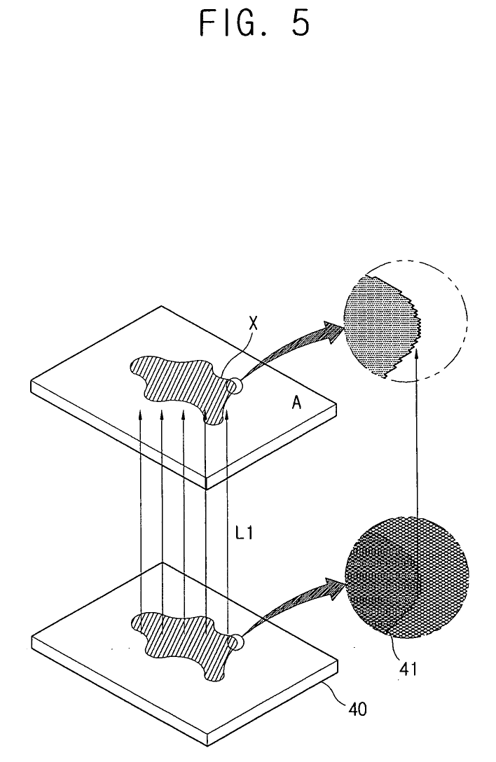

Therefore, the light paths of laser beams L1 incident into the object A are changed according to the directions of the micromirrors 41. As a result, the area processed on the object A is also changed. Therefore, as shown in FIG. 5, the irradiated laser beams L1 arrive at the area to be processed X on the surface of the object A, thereby processing the object A. As described above, each of the micromirrors is formed in a very small size, which is determined by a micro unit. Therefore, there is an advantage in that it is possible to easily process an object by directly irradiating laser beams, even if the shape to be processed is intricate. Here, FIG. 5 is a conceptual view illustrating a method of processing an intricate shape of an object by using the inventive laser processing device.

Now, description will be made how to control the power of laser beams arriving at a processing area X.

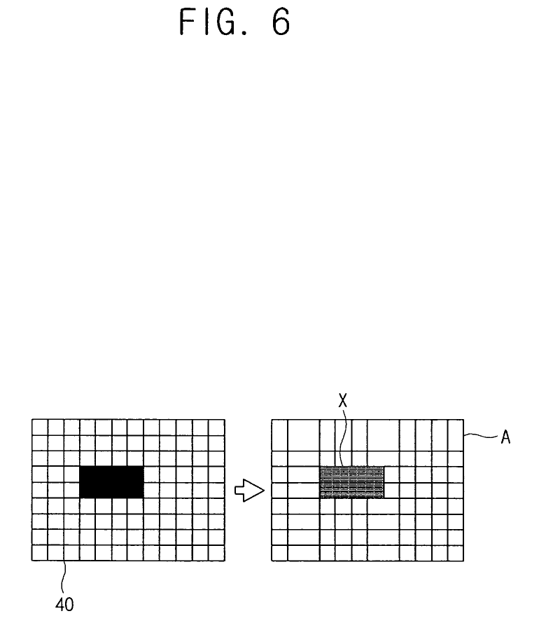

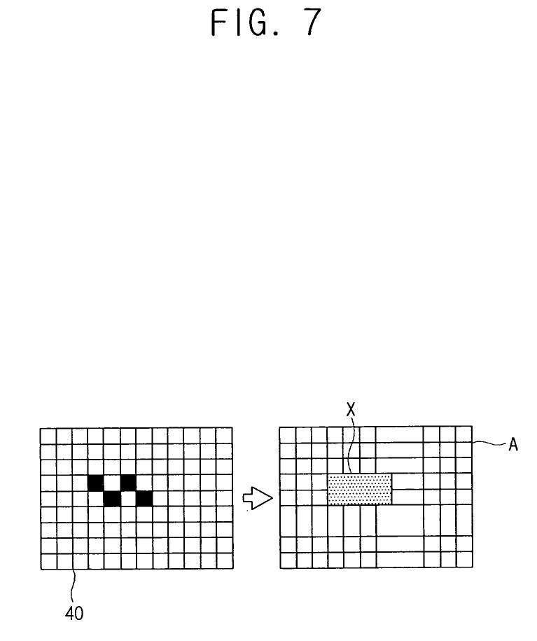

FIGS. 6 to 10 are conceptual views illustrating the variation of power of laser beams according to the movement of the micromirrors in the inventive laser processing device. As shown, description will be made as to how to control the power of laser beams L1 by controlling each of the micromirrors 41 determining the directions of the laser beams L1 arriving at the processing area X so as to control the shape and the depth D1 of the processing area X.

At first, if the light paths of all the micromirrors 41 arrive at the processing area X are directed to the object A as shown in FIG. 6, the power of the laser beams L1 arriving at the object A is maintained without changing. Meanwhile, if the light paths of some of the micromirrors 41 arriving at the processing area X are directed to the object A, the power of the laser beams L1 arriving at the object A is reduced depending on the amount of the laser beams which have changed the light paths not to be directed to the processing area X. For example, if the light paths of one fourth of the micromirrors are made to be directed to the processing area X on the object A, the power of the laser beams arriving at the processing area X on the object A will be reduced to one fourth.

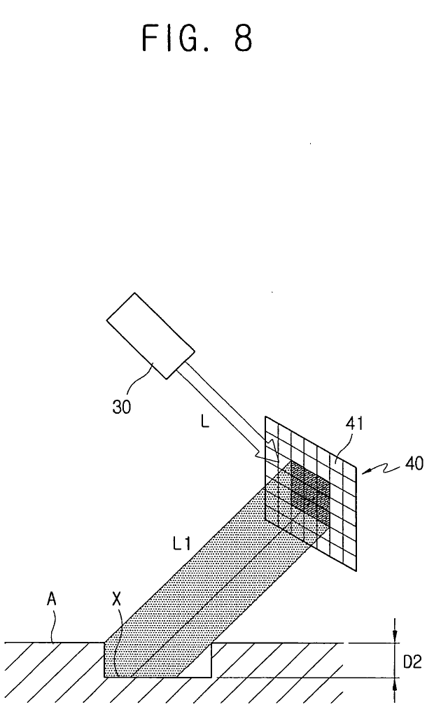

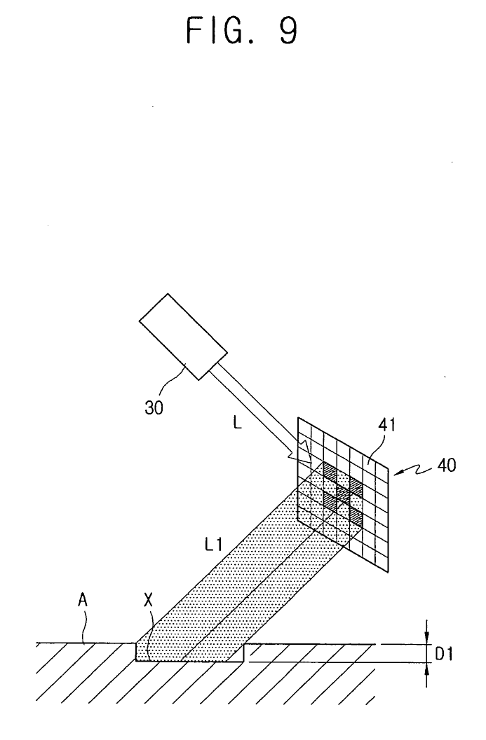

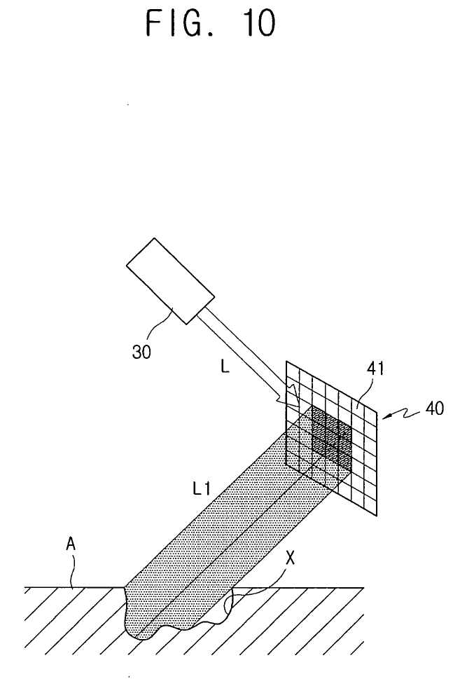

By controlling the power of the laser beams arriving at the processing area X depending on the processing area in this manner, it is possible to control the depth of the processing area X. That is, the processing depth D1 obtained when all the micromirrors 41 corresponding to the processing area as shown in FIG. 8 is deeper than the processing depth D2 obtained when some of the micromirrors 41 are directed to the object as shown in FIG. 9, because the power of the laser beams L1 applied in the former case is larger than that applied in the latter case. As a result, by controlling the laser beams depending on the processing area, it is possible to implement a three-dimensional process as shown in FIG. 10.

Next, description will be made as to how to control the power of laser beams arriving at the processing area by controlling the time for switching the micromirrors of the micromirror device. In general, each of the micromirrors is configured so that its direction can be changed several times to several thousands of times per one second. As a result, by controlling the length of time for switching each of the micromirrors, it is possible to control the power of the laser beams. For example, in order to process one area (first area) on the processing surface of an object more deeply than another area (second area), the length of time for switching the micromirrors adapted to reflect laser beams to the first area is set to be longer than the length of time for switching the micromirrors adapted to reflect laser beams to the second area so that the first area is illuminated by the laser beams for a long time as compared to the second area. As a result, the first area can be processed more deeply than the second area. For example, with a micromirror capable of being switched for 1/300 seconds, if the micromirror is made to be switched in such a manner that laser beams can be irradiated to the first area 90 times per sec (this means that laser beams are made to be irradiated to the one area for 90/300 seconds), and laser beams can be irradiated to the second area 30 times per sec (this means that laser beams are made to be irradiated to the second area for 30/300 seconds), the power of the laser beams irradiated to the first area will be three times of the power of the laser beams irradiated to the second area. As a result, there will be a difference in processing depth between the two areas, which enables the three-dimensional process.

In addition, by controlling the switching times of each micromirror per unit time, it is possible to control the minimum processing unit. In such a case, a principle is employed that there will be a difference in length of time for irradiating laser beams between controlling the length of time for switching such a micromirror one time to 1/300 seconds, for example, and controlling the length of time for switching such a micromirror one time to 1/200 seconds, for example. In other words, by controlling the length of time for switching a mirror one time, it is possible to control the processing depth obtained by irradiating laser beams one time. That is, for one time switching period, the illumination time with the laser beams irradiated by a micromirror controlled to be switched 300 times per sec is about ⅔ of the illumination time with the laser beams irradiated by a micromirror controlled to be switched 200 times per sec. As a result, the amount processed by illuminating the laser beams one time with the former mirror is smaller than that obtained by illuminating the laser beams one time with the latter mirror. Accordingly, it is possible to execute more precise three-dimensional process if the times of switching the micromirrors per unit time and the length of time for switching the micromirrors are controlled.

If the times for switching the micromirrors per unit time and the length of time for switching the micromirrors are controlled simultaneously with controlling the number of micromirrors rendering laser beams to arrive at a surface to be processed, it is possible to more precisely and variously control the power of the laser beams, which enables more precise surface processing.

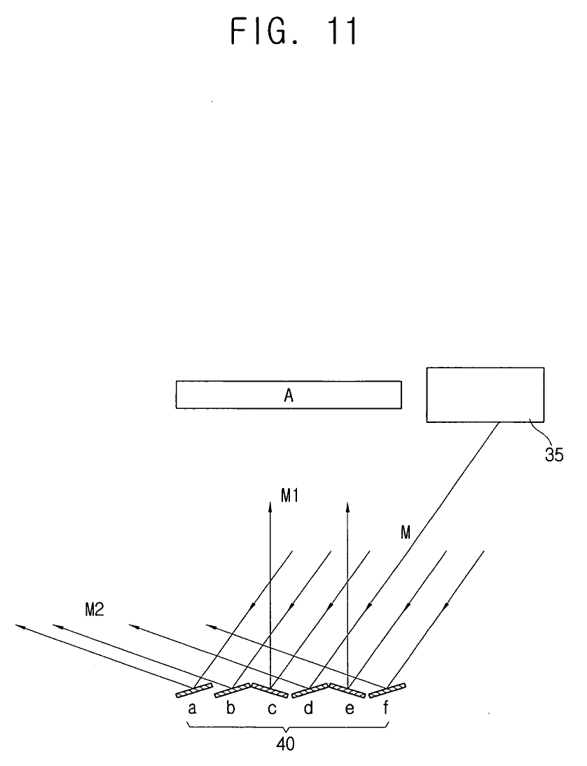

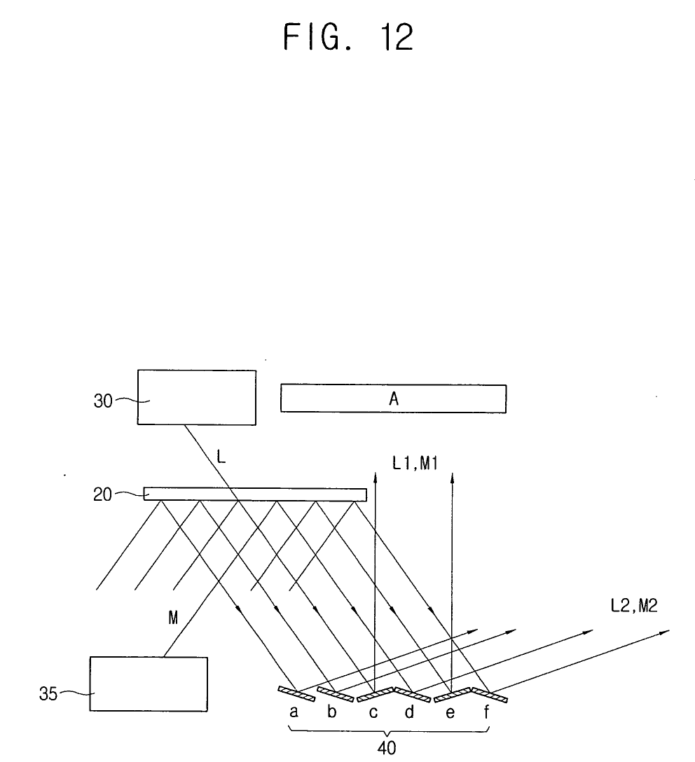

Next, the auxiliary beam generating unit of the inventive laser processing device will be described with reference to FIGS. 11 and 12. FIG. 11 is a cross-sectional view illustrating an embodiment of an auxiliary beam generating unit in the inventive laser processing device, and FIG. 12 is a cross-sectional view illustrating another embodiment of the auxiliary beam generating unit in the inventive laser processing device.

As shown in FIG. 11, the inventive laser processing device may further comprise an auxiliary beam generating unit 35. The auxiliary beam generating unit 35 may be arranged on a light path different from that of the laser beam generating unit (see FIG. 3), and the auxiliary beams M generated by the auxiliary beam generating unit 35 are reflected by the micromirrors 41, and only the auxiliary beams M1 selected from the reflected auxiliary beams are irradiated to the object A. Accordingly, it is possible to observe in detail the surface to be processed on the object with the auxiliary beams M1.

The same micromirror device 40 can be used when the object is observed with the auxiliary beams and the object is processed by the laser beams. If the respective positions of the micromirrors selected in the micromirror device 40 when the object is processed with the laser beams are set to be different from those of the micromirrors selected in the micromirror device 40 when the object is observed with the auxiliary beams, it is possible to process as well as to observe the same area.

That is, it is impossible to simultaneously perform the processing of the object with the laser and the observation of the object with the auxiliary beams. It is possible to selectively perform one of the observation of the object with the auxiliary beams and the processing of the object with the laser beams, depending on the switching positions of the micromirrors.

Unlike this, by employing a dichroic mirror 20 as shown in FIG. 12, it is possible to simultaneously perform the observation of the object with the auxiliary beams and the processing of the object with the laser beams. Among the beams, the dichroic mirror 20 selectively reflects beams of a selective wavelength and transmits the remaining beams. Such a dichroic mirror 20 is employed so as to allow laser beams to pass through it without loss of wavelength.

As shown in FIG. 12, the inventive laser processing device may further comprise a dichroic mirror 20, wherein the dichroic mirror 20 may render the light path of the auxiliary beams M emitting from the auxiliary beam generating unit 30 to be equal to that of the laser beams L emitting from the laser beam generating unit.

By employing the dichroic mirror 20, all the laser beams are transmitted through the dichroic mirror 20, but the auxiliary beams M are only partially transmitted through the dichroic mirror 20 and partially reflected by the dichroic mirror 20. As such, the auxiliary beams M reflected by the dichroic mirror 20 are incident into the respective micromirrors while maintaining the same paths as the laser beams L.

The laser beams L1 and the auxiliary beams M1 are incident into the object A along the same paths. Therefore, it is possible to simultaneously perform the observation of the object and the processing of the object with the laser beams. Unlike this, it is possible to separately perform the observation of the object and the processing of the object with the laser beams. Meanwhile, it is possible to accomplish the above-mentioned objects and effects even if a beam splitter is employed beyond the dichroic mirror as described above.

While the present invention has been described with reference to the particular illustrative embodiments, it is not to be restricted by the embodiments but only by the appended claims, and therefore, it is to be understood that other modifications and variations may be made without departing from the substance and scope of the present invention, as those skilled in the art will readily understand. Such alternate modifications and variations are within the scope of the present invention which is intended to be limited only by the appended claims and equivalents thereof.

According to the inventive laser processing device configured as described above, it is possible to precisely process a intricately shaped or curved object within a short length of time unlike the prior art.

By controlling the power of laser beams, it is possible to control the depth of a processing area as well as to process the processing area in a three-dimensional shape.

In addition, by controlling the power of laser beams, it is possible to control a depth processed on an object.

Furthermore, by employing auxiliary beams at the time of processing an object with laser beams, it is possible to process the object while observing a processing shape.

1-8. (canceled)

9. A laser processing device for processing a surface of an object with laser beams comprising:
a laser beam generating unit for projecting laser beams; and
a micromirror device having a plurality of micromirrors, the micromirrors being configured to reflect and transfer at least a part of laser beams projected from the laser beam generating unit to the surface of the object in a pattern for processing the surface of the object in a desired shape,
wherein the micromirror is capable of selectively switching the light path of a laser beam projected from the laser beam generating unit and the micromirror device controls the power of laser beams irradiated to an area of the surface of the object desired to be processed by switching the light paths of some of the micromirrors corresponding to the area of the surface of the object to be processed.

10. A laser processing device for processing a surface of an object with laser beams comprising:
a laser beam generating unit for projecting laser beams; and
a micromirror device having a plurality of micromirrors, the micromirrors being configured to reflect and transfer at least a part of laser beams projected from the laser beam generating unit to the surface of the object in a pattern for processing the surface of the object in a desired shape,
wherein the micromirror is capable of selectively switching the light path of a laser beam projected from the laser beam generating unit and the micromirror device controls the power of laser beams irradiated from a micromirror by controlling the length of time for switching the light path of the micromirror.

11. The laser processing device as defined in claim 9, wherein each micromirror is adapted to take one of two positions when electric voltage is applied to an area on the micromirror, so that the micromirror can selectively switch the light path among two light paths.

12. The laser processing device as defined in claim 9, wherein the micromirror device is a digital micromirror device, which executes the selection of a desired light path through a semiconductor switching circuit control circuit.

13. The laser processing device as defined in claim 10, wherein the micromirror device controls a processing depth of the surface of the object to be processed by controlling the times of switching the light path of the micromirror per unit time.

14. The laser processing device as defined in claim 9, further comprising an auxiliary beam generating unit separately arranged from the light path of the laser beam generating unit so as to generate auxiliary beams, so that the surface of the object desired to be processed can be observed.

15. The laser processing device as defined in claim 14, further comprising a dichroic mirror for rendering the light paths of the auxiliary beams projected from the auxiliary beam generator to be equal to the light paths of the laser beams projected from the laser beam generating unit.

16. The laser processing device as defined in claim 10, wherein each micromirror is adapted to take one of two positions when electric voltage is applied to an area on the micromirror, so that the micromirror can selectively switch the light path among two light paths.

17. The laser processing device as defined in claim 10, wherein the micromirror device is a digital micromirror device, which executes the selection of a desired light path through a semiconductor switching circuit control circuit.

18. The laser processing device as defined in claim 10, further comprising an auxiliary beam generating unit separately arranged from the light path of the laser beam generating unit so as to generate auxiliary beams, so that the surface of the object desired to be processed can be observed.
